(19) United States
(12) Patent Application Publication
(10) Pub. No.: US 2012/0043839 A1
(43) Pub. Date: Feb. 23, 2012

(54) CONNECTING STRUCTURE FOR RELAY TERMINAL

(75) Inventors: Sho Miyazaki, Yokkaichi-City (JP); Satoshi Tsuruta, Yokkaichi-City (JP)

(73) Assignee: SUMITOMO WIRING SYSTEMS, LTD., Yokkaichi-City (JP)

(21) Appl. No.: 13/206,743

(22) Filed: Aug. 10, 2011

(30) Foreign Application Priority Data
Aug. 18, 2010 (JP) 2010-183306

(51) Int. Cl. H01R 9/24; H02K 3/28

(52) U.S. Cl. 310/71; 439/709

(57) ABSTRACT

A connecting structure for relay terminals (10) made of enameled wires and adapted to electrically connect motor side terminals (51) provided on a motor (50) and inverter side terminals (61) provided on an inverter (60) includes motor side annular connecting portions (11) to be connected to the motor side terminals (51), inverter side annular connecting portions (12) to be connected to the inverter side terminals (61) and coil springs (13) spirally wound and electrically conductively connecting the motor side annular connecting portions (11) and the inverter side annular connecting portions (12).

### BACKGROUND OF THE INVENTION

1. Field of the Invention

The present invention relates to a connecting structure for relay terminal.

2. Description of the Related Art

Devices such as a motor fixed to an engine and an inverter are mounted in a hybrid vehicle. The motor is connected to the inverter by a wiring harness such as a power cable.

U.S. Patent Application Publication No. 2004/0124332 and FIG. 10 herein show a known structure in which a motor 1 and an inverter 2 are untied for space saving and are connected electrically by relay terminals 3. The relay terminals 3 are in the form of straight bars and directly connect three motor terminals 5 on the motor 1 and three inverter terminals 6 on the inverter 2. In this way, a wiring harness for connecting the motor 1 and the inverter 2 can be omitted.

The motor 1 is fixed to an engine and vibration from the engine is transmitted directly to the relay terminal 3 via the motor 1. Vibration generated from the inverter 2 also is transmitted directly to the relay terminals 3. The vibrations from the engine and from the inverter 2 have different frequencies. Thus, vibrations having different frequencies are transmitted simultaneously to the relay terminals 3. Resonance occurs at or near the natural frequency of the relay terminals 3 and metal fatigue progresses. As a result, there is a problem of crack and cut.

The invention was developed in view of the above situation and an object thereof is to improve lifetime of a relay terminal.

A further object of the invention is to suppress damage of a relay terminal due to metal fatigue and to improve the lifetime of a relay terminal by absorbing vibrations transmitted from devices.

### SUMMARY OF THE INVENTION

The invention relates to a connecting structure for a relay terminal made of an enameled wire. The connecting structure is adapted to electrically connect a first device side terminal on a first device to a second device side terminal on a second device. The relay terminal comprises: a first connecting portion to be connected to the first device side terminal; a second connecting portion to be connected to the second device side terminal; and at least one vibration absorbing portion electrically conductively connecting the first and second connecting portions. The vibration absorbing portion has a wound configuration.

The vibration absorbing portion may be spirally wound about a line connecting the first and second connecting portions as an axial center.

The spirally wound vibration absorbing portion of the above-described relay terminal connecting structure absorbs vibrations transmitted to the relay terminal from the first and second device side terminals and hence suppresses damage to the relay terminal due to metal fatigue.

A plurality of relay terminals may be provided and may be arranged so that the positions of the axial centers of the respective vibration absorbing portions substantially align. For example, the plural vibration absorbing portions may be arranged in series in a vertical direction so that the positions of the axial centers of the respective vibration absorbing portions substantially align. Thus, an area taken up by the vibration absorbing portions can be reduced in a lateral direction as compared with the case where the vibration absorbing portions are juxtaposed in the lateral direction.

The vibration absorbing portion may comprise at least one coil spring extending in a direction of the axial center of the vibration absorbing portion. Accordingly, vibrations transmitted from the first and second devices can be absorbed by resilient deformation of the coil spring in the direction of the axial center. Thus, the relay terminal is not likely to be damaged by metal fatigue.

The enamel wires may be arranged at intervals in a circumferential direction about the axial centers of the vibration absorbing portion in a cross section of the vibration absorbing portion perpendicular to the direction of the axial centers. Thus, for example, in the case of three relay terminals, three coil springs are wound spirally together. This enables an area taken up by the coil springs to be reduced in the vertical direction as compared with the case where the coil springs are arranged in series in the vertical direction.

The first device may comprise a three-phase motor fixed to an engine and the first device side terminal may be three motor side terminals provided on the three-phase motor. The second device may comprise an inverter and the second device side terminal may be three inverter side terminals provided on the inverter. Corresponding pairs of the motor side terminals and the inverter side terminals may be connected individually by three relay terminals. Thus, the relay terminals of the invention can connect the three-phase motor and the inverter having different vibration frequencies.

The first connecting portion may be fastened to the first device side terminal and fixed to a portion of a terminal block by inserting a fastening bolt through a bolt insertion hole of the first device side terminal and the inside of the first connecting portion and tightening the fastening bolt to the terminal block. The second connecting portion may be fastened to the second device side terminal and fixed to a portion of the terminal block particularly by inserting a fastening bolt through a bolt insertion hole of the second device side terminal and the inside of the second connecting portion and tightening the fastening bolt to the terminal block.

The vibration absorbing portion may be arranged near a side surface of a terminal block.

The first and second connecting portions may include first and second relay wires bent at an angle and preferably substantially perpendicularly after extending substantially straight up to a side surface of a terminal block.

The vibration absorbing portion preferably is covered at least partly by a protection cover. The protection cover may be mounted to a terminal block by tapping screws inserted through respective mounting pieces.

At least one slit may be formed in the protection cover to accommodate at least one first relay wire extending from the first connecting portion. The slit may be dimensioned so that small clearances are formed between the first relay wire and an edge of the slit.

The vibration absorbing portion may comprise plural coil springs wound spirally together with their axial centers substantially aligned to define a plural spiral structure. The coil springs may substantially have equal diameters.

These and other features and advantages of the invention will become more apparent upon reading the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a front view of three relay terminals of a first embodiment juxtaposed between a motor and an inverter with a protection cover partly in section.

FIG. 2 is a plan view showing the three relay terminals of the first embodiment juxtaposed between the motor and the inverter.

FIG. 3 is a bottom view of the state of FIG. 2.

FIG. 4 is a side view of the relay terminals of the first embodiment arranged between the motor and the inverter with the protection cover partly in section.

FIG. 5 is a front view of relay terminals of a second embodiment arranged between a motor and an inverter with a protection cover partly in section.

FIG. 6 is a plan view showing the relay terminals of the second embodiment arranged between the motor and the inverter.

FIG. 7 is a bottom view showing the state of FIG. 6.

FIG. 8 is a side view of the relay terminals of the second embodiment arranged between the motor and the inverter with the protection cover partly in section.

FIG. 9 is an enlarged section showing coil spring parts of FIG. 6 cut in a direction perpendicular to a direction of axial centers.

FIG. 10 is a partial section of a prior art relay terminal mounting structure.

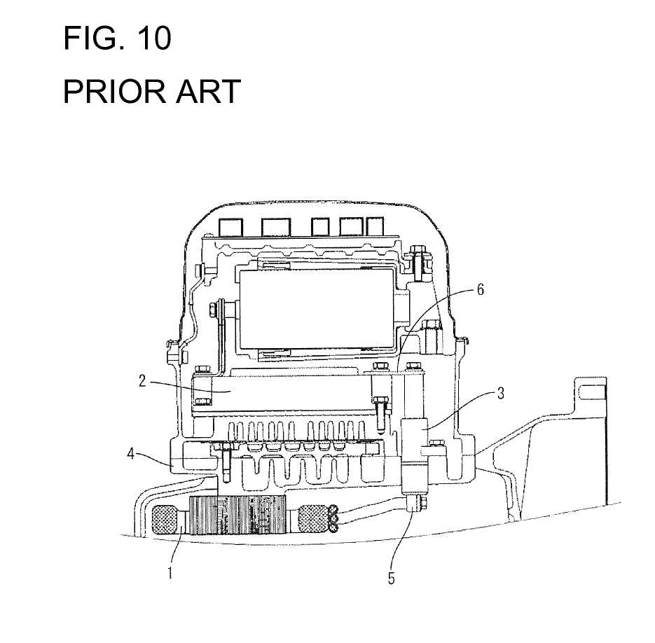

### DETAILED DESCRIPTION OF THE PREFERRED EMBODIMENTS

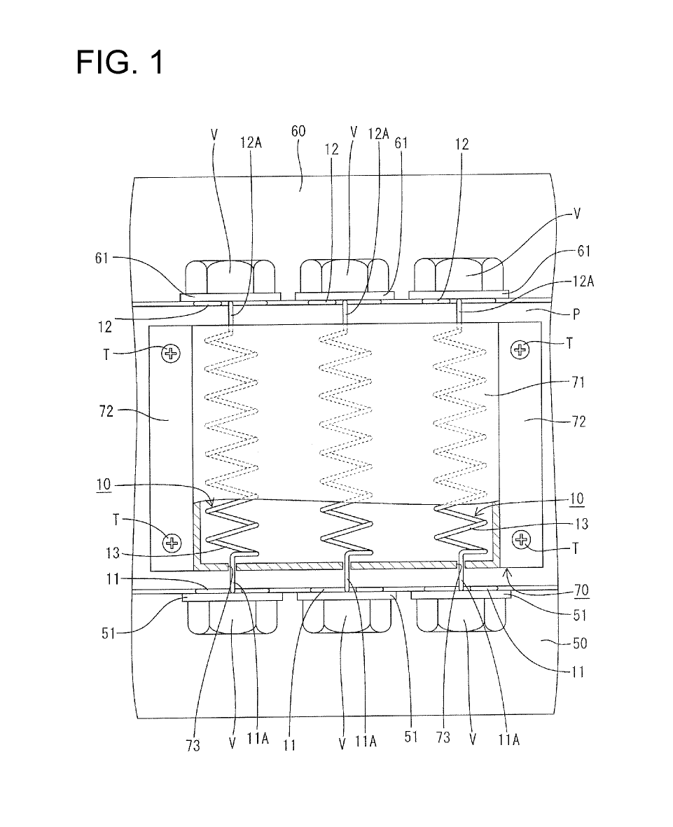

FIGS. 1 to 4 illustrate a first embodiment of a connecting structure for relay terminals 10 that electrically connect a motor 50 fixed to an unillustrated engine and an inverter 60. The connecting structure preferably is used in a vehicle, such as a hybrid vehicle or an electric vehicle.

The motor 50 and the inverter 60 are housed in the same case (not shown) and are partitioned by an unillustrated partition wall. The motor 50 is used in the housing with a fluid for cooling (e.g. ATF) showered thereon.

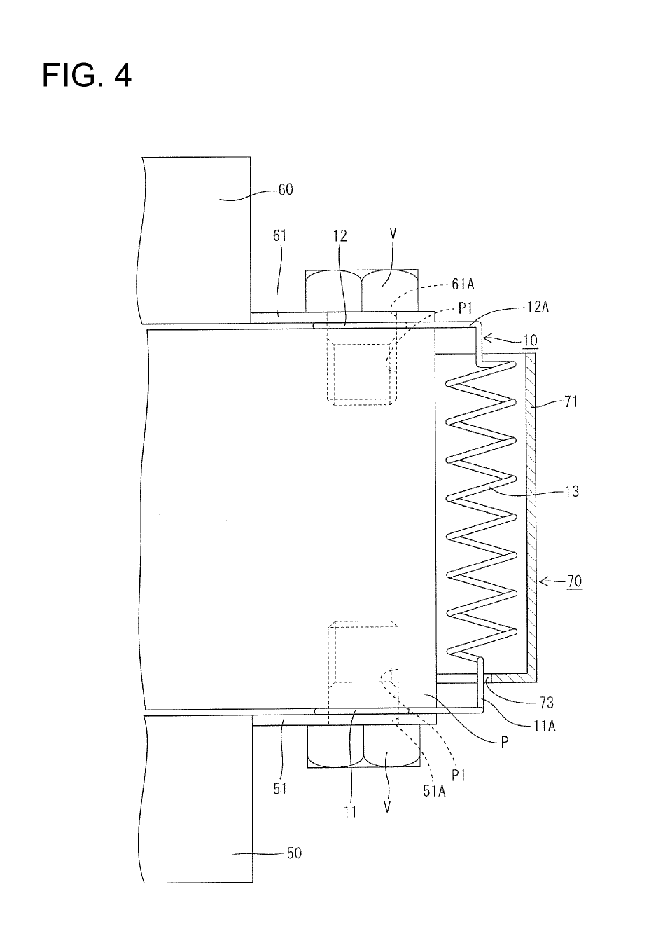

The motor 50 includes three motor side terminals 51, as shown in FIGS. 1 and 4. Each motor side terminal 51 is formed with a bolt insertion hole 51A through which a fastening bolt V is insertable.

Similarly, the inverter 60 includes three inverter side terminals 61. Each inverter side terminal 61 is formed with a bolt insertion hole 61A, through which a fastening bolt V is insertable.

The relay terminals 10 are formed by bending enameled wires and, in this embodiment, three relay terminals 10 are juxtaposed in a lateral direction, as shown in FIG. 1.

Each relay terminal 10 includes a motor side annular connecting portion 11 located at a first distal end (e.g. a lower end) and an inverter side annular connecting portion 12 located at a second distal end (e.g. an upper end) as shown in FIG. 1.

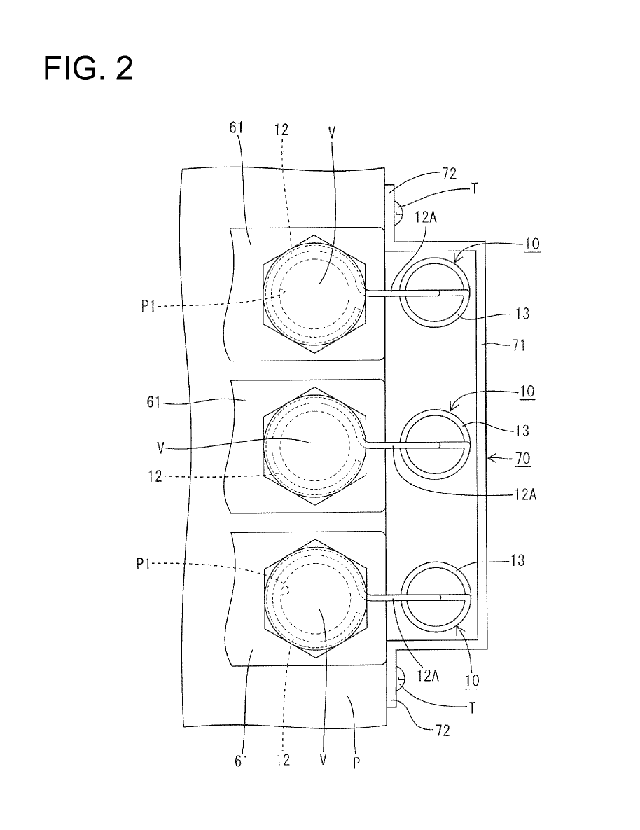

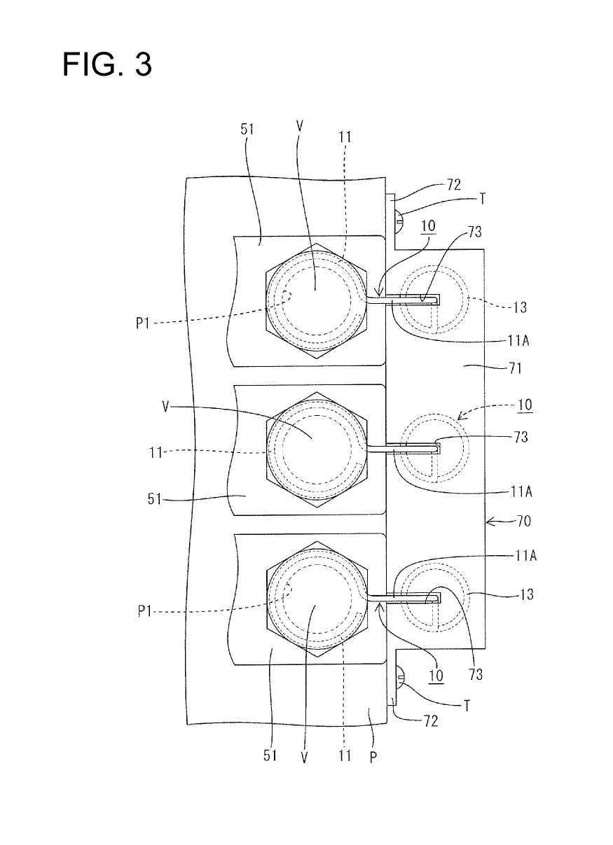

The motor side annular connecting portion 11 and the inverter side annular connecting portion 12 are annular and have insulation coatings removed therefrom to expose conductors, as shown in FIGS. 2 and 3.

The fastening bolts V are insertable through the insides of the motor side annular connecting portions 11 and the inverter side annular connecting portions 12.

As shown in FIGS. 1 and 3, each motor side annular connecting portion 11 is fastened to the motor side terminal 51 and fixed to the lower surface of a terminal block P by inserting the fastening bolt V through the bolt insertion hole 51A of the motor side terminal 51 and the inside of the motor side annular connecting portion 11 and tightening the fastening bolt V to the terminal block P provided on the partition wall. Similarly, each inverter side annular connecting portion 12 is fastened to the inverter side terminal 61 and fixed to the upper surface of the terminal block P by inserting the fastening bolt V through a bolt insertion hole 61A of the inverter side terminal 61 and the inside of the inverter side annular connecting portion 12 and tightening the fastening bolt V to the terminal block P as shown in FIGS. 1 and 3.

Note that three bolt holes P1 are formed side by side in the lateral direction in each of the upper and lower end surfaces of the terminal block P and the respective motor side terminals 51 and the respective inverter side terminals 61 are to be fixed to the terminal block P.

The relay terminals 10 electrically connect the motor side terminals 51 and the inverter side terminals 61 by being fixed at outer ends of the terminal block P by the fastening bolts V. Note that the motor side terminals 51 and the inverter side terminals 61 are arranged so that the corresponding pairs of the terminals 51, 61 are aligned (particularly vertically) and are connected individually by the respective relay terminals 10 juxtaposed in the lateral direction, as shown in FIG. 1.

Each motor side annular connecting portion 11 includes a motor side relay wire 11A that extends straight to a side surface of the terminal block P and then is bent substantially perpendicularly up and each inverter side annular connecting portion 12 includes an inverter side relay wire 12A that extend straight to the side surface of the terminal block P and then is bent substantially perpendicularly down, as shown in FIG. 4.

A resilient vibration absorbing coil spring 13 extends unitarily between the motor side relay wire 11A of the motor side annular connecting portion 11 and the inverter side relay wire 12A of the inverter side annular connecting portion 12 of each relay terminal 10. The coil springs 13 are arranged near the side surface of the terminal block P and are covered at least partly by a protection cover 70 made e.g. of synthetic resin.

As shown in FIGS. 2 and 4, the protection cover 70 includes a substantially rectangular covering portion 71 that is open at an upper side and a side facing the terminal block P. Two mounting pieces 72 are provided at the opposite lateral edges of an opening of the covering portion 71.

Three slits 73 are formed in the lower end surface of the covering portion 71 and accommodate the three respective motor side relay wires 11A extending from the motor side annular connecting portions 11. As shown in FIG. 3, the slits 73 are dimensioned so that small clearances are formed between the motor side relay wires 11A and edges of the slits 73, thereby making it difficult for ATF oil and the like in the motor 50 to enter the covering portion 71. Note that a measure to prevent oil such as an unillustrated cover is taken at a lower part of the protection cover 70 so that ATF oil and the like do not enter through the clearances between the motor side relay wires 11A and the slits 73.

Tapping screws T are inserted through the mounting pieces 72 and tightened to the side surface of the terminal block P for fixing the protection cover 70 to the terminal block P.

As shown in FIGS. 2 and 4, each coil spring 13 is wound spirally in a clockwise direction at a substantially uniform pitch from an upper end near the inverter 60 to a lower end near the motor 50 and is concentric about an imaginary straight line connecting the inverter side relay wire 12A and the motor side relay wire 11A. The coil spring 13 is resiliently deformable in a vertical direction and hence can expand or contract from a normal unbiased length.

The relay terminals 10 are connected directly to the motor side terminals 51 and the inverter side terminals 61. Thus, vibrations generated by the unillustrated engine fixed to the motor 50 and to the inverter 60 are transmitted directly to the relay terminals 10. The relay terminals 10 are subject to the vibration transmitted from the motor 50 and from the inverter 60 until the vehicle stops and hence the relay terminals 10 vibrate constantly.

Further, high-frequency vibration of the engine transmitted via the motor 50 and low-frequency vibration transmitted from the inverter 60 differ in frequency so that the relay terminals 10 vibrate irregularly. However, the coil springs 13 are wound spirally in central parts of the relay terminals 10. Accordingly, vertical resilient deformations of the coil springs absorb vibrations at both upper and lower ends of the relay terminals 10 to suppress damage, such as cracks and cuts, due to metal fatigue.

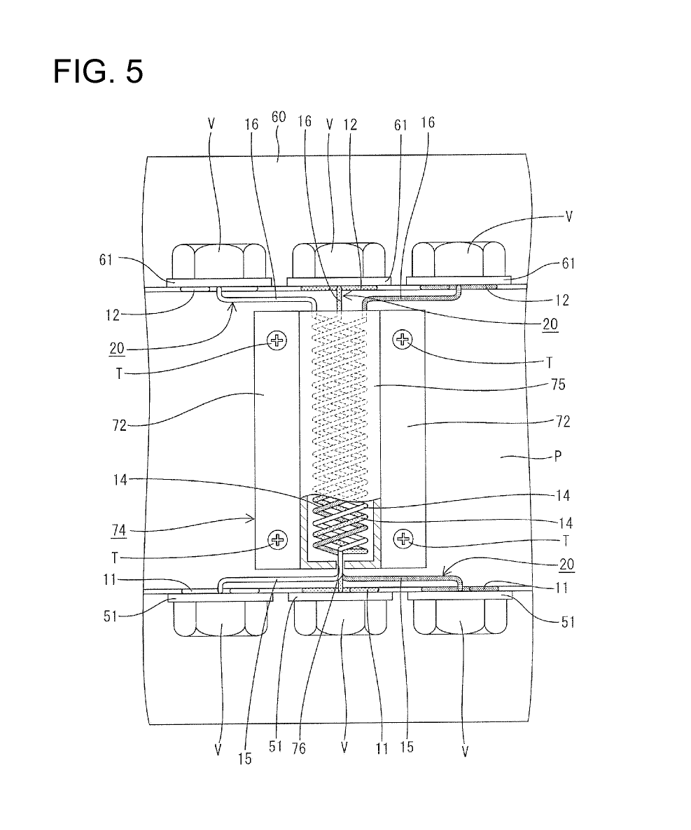

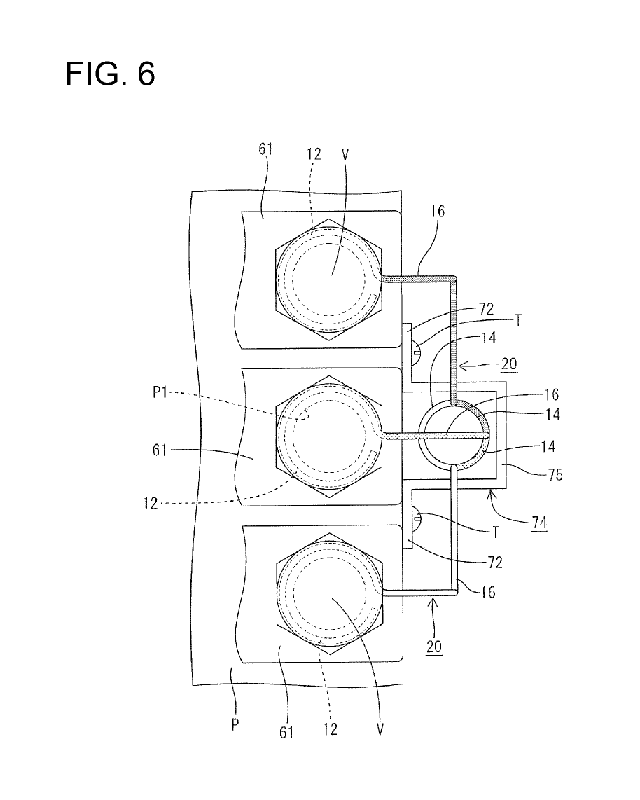

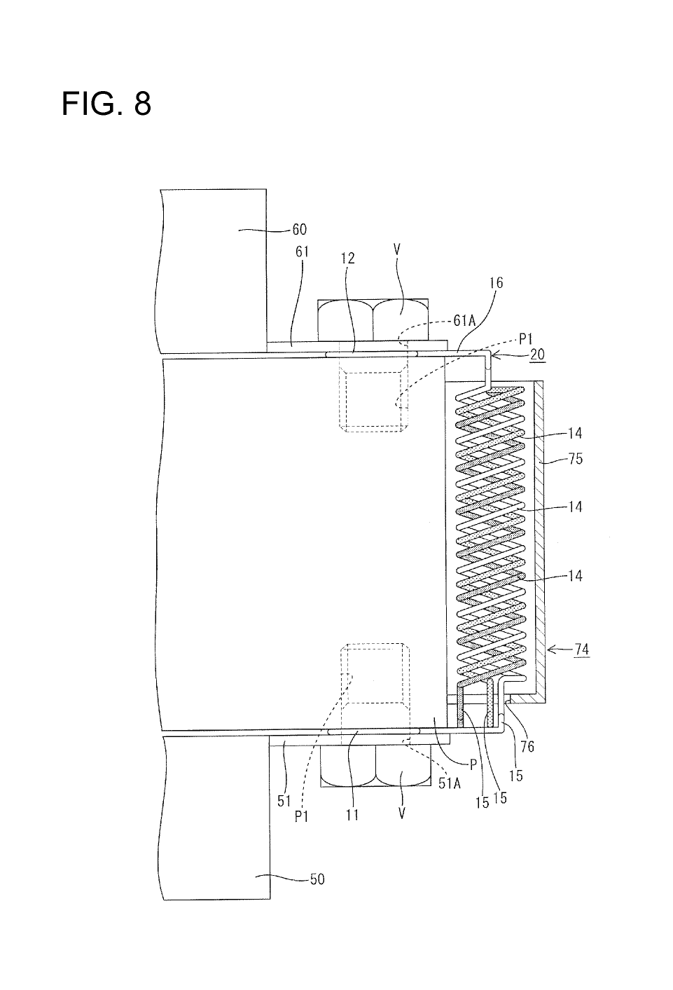

Relay terminals 20 of a second embodiment of the invention are illustrated in FIGS. 5 to 9. The relay terminals 20 differ from the relay terminals 10 of the first embodiment with respect to parts of the coil springs 13, the motor side relay wires 11A and the inverter side relay wires 12A. Elements of the second embodiment that are the same as or similar to the first embodiment are identified by the same reference numerals, but are not described again. The relay terminals 20 of the second embodiment have three coil springs 14 of equal diameters spirally wound around the same axial center to define a triple spiral structure. More specifically, as shown in FIG. 5, respective relay wires 15 extending from motor side annular connecting portions 11 at the opposite ends and inverter side relay wires 16 extending from inverter side annular connecting portions 12 at the opposite ends are pulled toward the three coil springs 14 that are wound spirally together. Windings of the coil springs 14 are in plural (e.g. three) levels so that pitches of the coil springs 14 are substantially uniform.

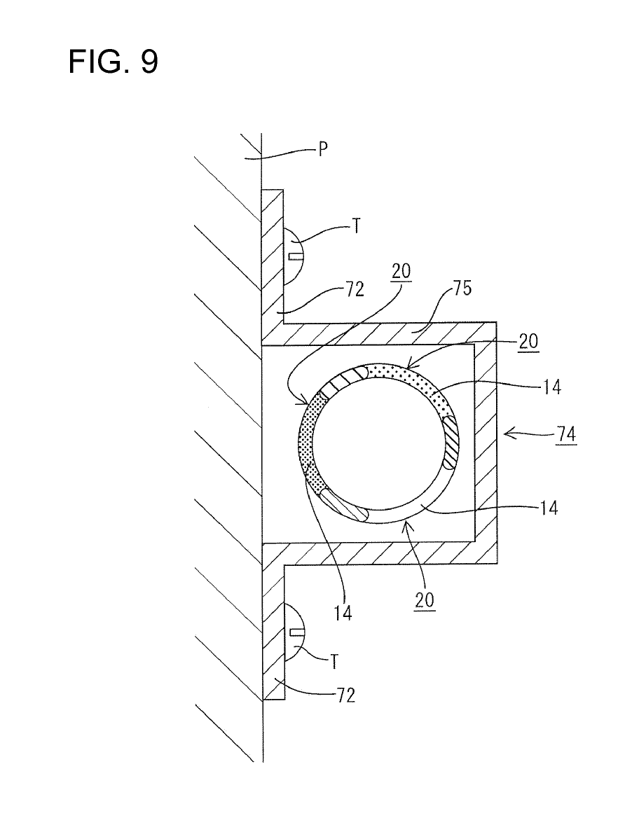

The enameled wires are arranged at substantially equal intervals in a circumferential direction about the axial centers of the coil springs 14, in a cross section perpendicular to the axial centers of the coil springs 14 shown in FIG. 9.

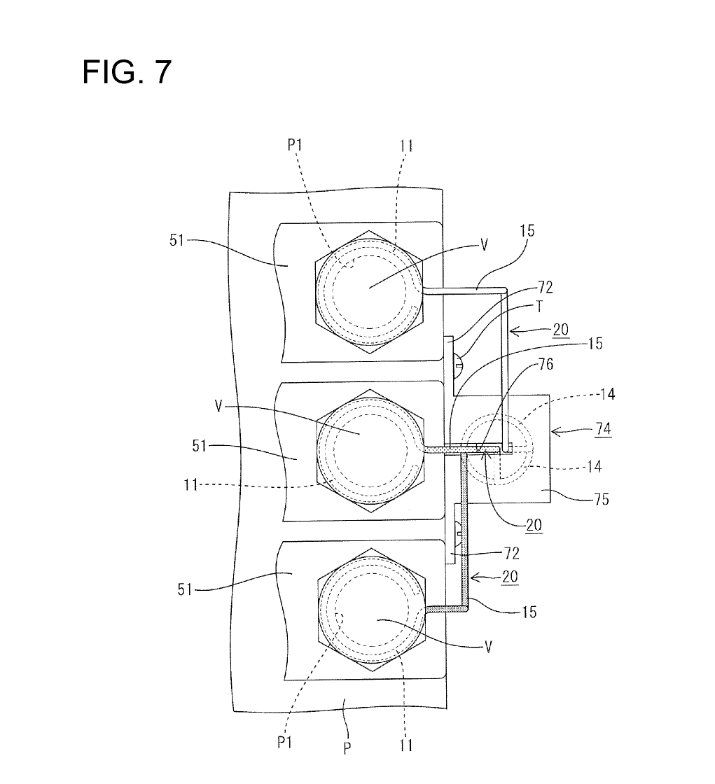

Spirally winding the coil springs 14 of the relay terminals 20 together reduces the width of a covering portion 75 of a protection cover 74 covering the coil springs 14 to less than about half (particularly about ⅓) and one slit 76 is formed in the bottom surface of the covering portion 75. Thus, the inverter side relay wires 16 extending from the lower ends of the respective coils 14 are pulled out from the slit 76 so as not to overlap each other, as shown in FIG. 7.

Generally, restriction on an arrangement space for electronic parts in a case uniting the motor 50 and the inverter 60 is quite large and great importance is attached to the saving of a space taken up by the relay terminals. This second embodiment reduces an area for arranging the coil springs 14, including the protection cover 74, to about ⅓ in the lateral direction as compared with the first embodiment.

In this way, it becomes possible to save the space taken up by the relay terminals 20 in the lateral direction and to absorb vibrations transmitted from the motor side terminals 51 and the inverter side terminals 61.

The invention is not limited to the above described and illustrated embodiments. For example, the following embodiments are also included in the technical scope of the present invention.

The coil springs of the relay terminals are covered by the protection cover that is open at the upper side and the side facing the terminal block P in the above embodiments. However, the invention is not limited to such a mode. For example, the coil springs may be covered by a protection cover covering the entire outer peripheral surfaces of the coil springs in the relay terminals or a protection cover that is open only at the side facing the terminal block P.

The coil springs 13 of the relay terminals 10 are wound spirally in the clockwise direction in the first embodiment. However, all or some of the coil springs 13 of the relay terminals 10 may be wound spirally in a counterclockwise direction.

The coil springs 14 of the three relay terminals 20 of the second embodiment are wound spirally together in the clockwise direction. However, the coil springs 14 of the three relay terminals 20 may be wound spirally together in the counterclockwise direction.

The coil springs 14 of the three relay terminals 20 are wound spirally together in the second embodiment. However, coil springs of more or fewer relay terminals may be wound spirally together.

The coil springs of the relay terminals are wound spirally at substantially equal pitches in the above embodiments. However, the spiral winding pitches may be irregular.

The motor side annular connecting portions 11 and the inverter side annular connecting portions 12 are fixed to the same terminal block P in the above embodiments. However, the motor side annular connecting portions 11 and the inverter side annular connecting portions 12 may be fixed respectively to different terminal blocks.

The coil springs 14 of the three relay terminals 20 are wound spirally together in the second embodiment. However, coil springs having different diameters may be arranged in concentric circles.

The central parts of the relay terminals 10, 20 are formed into the coil springs in the above embodiments. However, the central parts of the relay terminals may be formed to have a conical spiral structure (spiral structure like a conch).

What is claimed is:

1. A connecting structure comprising at least one relay terminal (10; 20) made of a wire for electrically connecting at least one first device side terminal (51) on a first device (50) and at least one second device side terminal (61) on a second device (60), the relay terminal (10; 20) comprising:
a first connecting portion (11) to be connected to the first device side terminal (51);
a second connecting portion (12) to be connected to the second device side terminal (61); and
a wound vibration absorbing portion (13; 14) electrically conductively connecting the first and second connecting portions (51, 61).

2. The connecting structure of claim 1, wherein the vibration absorbing portion (13; 14) is wound spirally about a line connecting the first and second connecting portions (51, 61).

3. The connecting structure of claim 1, wherein the at least one relay terminal (10; 20) comprises plural relay terminals (10; 20) arranged so that axial centers of the respective vibration absorbing portions (13; 14) substantially are aligned.

4. The connecting structure of claim 3, wherein the vibration absorbing portions (13; 14) comprise coil springs (13; 14) extending in a direction of the axial centers of the vibration absorbing portion (13; 14).

5. The connecting structure of claim 3, wherein the wires are arranged at intervals in a circumferential direction about the axial centers of the vibration absorbing portion (13; 14) in a cross section of the vibration absorbing portion (13; 14) perpendicular to the direction of the axial centers.

6. The connecting structure of claim 1, wherein:
the first device (50) is a three-phase motor fixed to an engine, the first device side terminal (51) comprises three motor side terminals (51) provided on the three-phase motor (50), the second device (60) is an inverter and the second device side terminal (61) comprises three inverter side terminals (61) provided on the inverter (60); and
corresponding pairs of the three motor side terminals (51) and the three inverter side terminals (61) are connected individually by three relay terminals (10; 20).

7. The connecting structure of claim 1, wherein the first connecting portion (11) is to be fastened to the first device side terminal (51) and fixed to a portion of a terminal block (P) by at least partly inserting a fastening bolt (V) through a bolt insertion hole (51A) of the first device side terminal (51) and the inside of the first connecting portion (11) and tightening the fastening bolt (V) to the terminal block (P) and wherein the second connecting portion (12) is to be fastened to the second device side terminal (61) and fixed to a portion of the terminal block (P) particularly by at least partly inserting a fastening bolt (V) through a bolt insertion hole (61A) of the second device side terminal (61) and the inside of the second connecting portion (12) and tightening the fastening bolt (V) to the terminal block (P).

8. The connecting structure of claim 1, wherein the vibration absorbing portion (13; 14) is arranged near a side surface of a terminal block (P).

9. A connecting structure of claim 8, wherein the first connecting portion (11) includes a first relay wire (11A) bent substantially perpendicularly after substantially extending straight up to a side surface of a terminal block (P) and the second connecting portion (12) includes a second side relay wire (12A) bent substantially perpendicularly or downward after substantially extending straight up to the side surface of the terminal block (P).

10. The connecting structure of claim 1, wherein the vibration absorbing portion (13; 14) is at least partly covered by a protection cover (70).

11. The connecting structure of claim 10, wherein the protection cover (70) is to be mounted to a terminal block (P) by tapping screws (T) inserted through respective mounting pieces (72).

12. The connecting structure of claim 10, wherein at least one slit (73) is formed in the protection cover (70), through which at least one respective first relay wire (11A) extending from the first connecting portion (11) is to be inserted.

13. The connecting structure of claim 12, wherein the slit (73) is so dimensioned that small clearances are formed between the first relay wire (11A) and an edge portion of the slit (73) in a state where the first relay wire (11A) extending from the first connecting portion (11) are inserted

14. The connecting structure of claim 1, wherein the vibration absorbing portion (13; 14) comprise at least two coil springs (14) spirally wound together with axial centers thereof substantially aligned to define a plural spiral structure.

15. The connecting structure of claim 14, wherein the coil springs (14) have substantially equal diameters.
